(19) United States
(12) Patent Application Publication
(10) Pub. No.: US 2011/0299428 A1
(43) Pub. Date: Dec. 8, 2011

(54) Dynamic Multiple Access Protocol for Use in an Audience Response System

(75) Inventors: Christopher M. Cacioppo, Somerville, MA (US); David J. Dean, Boston, MA (US)

(73) Assignee: SANFORD, L.P., Oak Brook, IL (US)

(21) Appl. No.: 13/101,232

(22) Filed: May 5, 2011

Related U.S. Application Data
(60) Provisional application No. 61/331,919, filed on May 6, 2010.

(51) Int. Cl. H04L 12/16

(52) U.S. Cl. 370/259

(57) ABSTRACT

A dynamic multiple access protocol for use in an audience response system. The audience response system includes a wireless aggregation point (e.g., a base station) and multiple handsets communicatively coupled to the wireless aggregation point. In order for the handsets to communicate effectively with the wireless aggregation point, the wireless aggregation point sends out, to the handsets, a beacon frame that specifies time slots during which the handsets may transmit data to the wireless aggregation point. However, the beacon frame does not assign any particular time slot to any particular handset. Instead, the handsets are free to select the time slots, specified by the beacon frame, during which to transmit data to the wireless aggregation point.

### CROSS-REFERENCE TO RELATED APPLICATION

The present application claims the benefit of U.S. Provisional Patent Application No. 61/331,919, entitled “DYNAMIC MULTIPLE ACCESS PROTOCOL FOR USE IN AN AUDIENCE RESPONSE SYSTEM,” filed on May 6, 2010, which is hereby incorporated by reference herein in its entirety.

### FIELD OF DISCLOSURE

The present disclosure relates generally to communication systems and, more particularly, to a dynamic multiple access technique for use in an audience response system.

### BACKGROUND

The background description provided herein is for the purpose of generally presenting the context of the disclosure. Work of the presently named inventors, to the extent it is described in this background section, as well as aspects of the description that may not otherwise quality as prior art at the time of filing, are neither expressly nor impliedly admitted as prior art against the present disclosure.

Audience response systems (ARS), in which group members use handsets to vote on topics, answer questions, confirm attendance, etc., are commonly used today to facilitate group interaction. Audience response systems can be employed for a variety of purposes and in various types of group environments. As one example, audience response systems are used by teachers in a classroom setting (e.g., to take attendance, or to administer tests and quizzes), and research indicates that there are various benefits to using audience response systems in such a setting. For instance, audience response systems reduce the effect of crowd psychology because, unlike hand raising, audience response systems may prevent students from seeing the answers of other students. For similar reasons, audience response systems may reduce instances of cheating in the classroom. Furthermore, audience response systems typically allow faster tabulation and display of answers and a more efficient tracking of individual responses and other data (e.g., response times of individual students). Additionally, audience response systems in classrooms have been shown to improve attentiveness, increase knowledge retention and generally create a more enjoyable classroom environment and a more positive learning experience.

In a typical audience response system architecture, multiple handsets associated with different users communicate wirelessly via a common wireless channel (e.g., using radio frequency or infrared communication technology) with one or more wireless aggregation points that generally collect and, possibly, process the data communicated by the audience via the handsets. A wireless aggregation point is typically (but not always) communicatively coupled to a control station, such as a personal computer, that runs a program that generally controls the operation of the audience response system. That is, the control station may be used to process information received from the handsets and to determine what information is sent to the handsets.

In order for an audience response system to function properly and effectively, the handsets typically need to share the common wireless channel without interfering with one another. Moreover, it is typically preferable that the handsets share the wireless channel in such a way as to maximize the capacity of the wireless channel. That is, it is usually desirable to reduce the instances of more than one handset trying to transmit data via the wireless channel at the same time, while also reducing the time that the wireless channel is idle (e.g., when at least one handset has data to transmit to the wireless aggregation point, but no handset is transmitting any data).

In order to share and/or maximize the capacity of the wireless channel, various multiple access schemes (also referred to as channel access schemes) have been developed. The most common multiple access schemes are the Time Division Multiple Access (TDMA) scheme and the Carrier Sense Multiple Access (CSMA) scheme. However, as will be described in more detail below, both TDMA and CSMA may lead to a suboptimal use of the wireless channel.

In an audience response system operating in accordance with the TDMA scheme, the wireless channel is divided into multiple time slots, and the time slots are assigned to particular handsets. Each handset can only transmit data via the wireless channel during the time slots (or a time slot) assigned to that handset. Consequently, an advantage of the TDMA scheme is that it ensures that no two handsets transmit data to the wireless aggregation point at the same time. However, if one handset does not have any data to transmit via the wireless channel during its assigned time slot, no other handset will be able to use that time slot, even if another handset does have data to transmit via the wireless channel. As a result, TDMA may lead to unused time slots, or “dead time,” resulting in suboptimal throughput in the wireless channel.

With respect to CSMA, although there exist various CSMA-like schemes, generally, a handset operating in accordance with the CSMA scheme checks for presence or absence of other traffic on the wireless channel before transmitting data via the channel. If there is no other traffic (i.e., the wireless channel is sensed idle), the handset will transmit its data via the wireless channel. Otherwise, the handset will “back off” and attempt to transmit its data via the wireless channel at a later time. If, at that later time, the wireless channel is sensed idle, the handset will transmit its data via the wireless channel. Otherwise, the handset will back off again and attempt to transmit its data via the wireless channel at another time. This process may continue until the handset finds a time when the wireless channel is idle and transmits its data via the wireless channel then.

As compared to TDMA, the CSMA scheme is more responsive to the amount of data that the individual handsets need to transmit. For example, under the CSMA scheme, a handset will not monopolize the wireless channel if that handset does not have any data to transmit via the wireless channel. However, CSMA may lead to suboptimal performance when, as often happens in a classroom setting, multiple handsets attempt to transmit information via the wireless channel at the same time (e.g., when a teacher poses a question to the class, and multiple students respond at approximately the same time). In such a scenario, multiple handsets attempting to transmit data via the wireless channel may sense an idle wireless channel and transmit their respective data, causing “collisions” and loss of data. At least some (if not all) handsets may have to retransmit their respective data, and data delivery may be delayed (resulting in higher latency).

Therefore, existing multiple access schemes such as TDMA and CSMA may result in a suboptimal use of the capacity of the wireless channel, at least with respect to throughput and latency.

### SUMMARY

The present disclosure generally describes a dynamic multiple access scheme for use in an audience response system.

In one embodiment, a method for communicating via a wireless communication channel for use in an audience response system is provided. The audience response system includes a wireless aggregation point and multiple handsets configured to communicatively couple to the wireless aggregation point via the wireless communication channel. The method includes receiving an input from a user at a given handset. The method further includes receiving a beacon data unit at the given handset via the wireless aggregation point. The beacon data unit specifies multiple time slots during which any one of the multiple handsets can transmit data to the wireless aggregation point. However, the beacon data unit does not assigning any particular time slots to any particular handsets. The method further includes selecting one of the multiple time slots specified in the beacon data unit. The method further includes transmitting data related to the input received from the user at the given handset from the given handset to the wireless aggregation point during the selected time slot.

In another embodiment, a wireless handset for use in an audience response system is provided. The audience response system includes a wireless aggregation point and multiple handsets configured to communicatively couple to the wireless aggregation point. The wireless handset includes a user interface configured to receive an input from a user. The wireless handset further includes a communication interface configured to receive a beacon data unit via the wireless aggregation point. The beacon data unit specifies multiple time slots during which any handset can transmit data to the wireless aggregation point, but the beacon data unit does not assign any particular time slots to any particular handsets. The communication interface is further configured to transmit data related to the input received from the user to the wireless aggregation point during a selected time slot. The wireless handset further includes a time slot selector configured to select the selected time slot.

In another embodiment, an audience response system includes a wireless aggregation point and multiple handsets communicatively coupled to the wireless aggregation point. The at least one handset includes a user interface configured to receive an input from a user. That handset further includes a communication interface configured to receive a beacon data unit via the wireless aggregation point. The beacon data unit specifies multiple time slots during which any handset can transmit data to the wireless aggregation point, but the beacon data unit does not assign any particular time slots to any particular handsets. The communication interface is further configured to transmit data related to the input received from the user to the wireless aggregation point during a selected time slot. The handset further includes a time slot selector configured to select the selected time slot.

In another embodiment, a method for use in a computing system configured to operate with an audience response system is provided. The audience response system includes a wireless aggregation point and multiple handsets configured to communicatively couple to the wireless aggregation point via the wireless communication channel. The computing system has a processor and a memory coupled to the processor. The memory stores computer-readable instructions that are executable on the processor.

The method includes generating a first beacon data unit. The first beacon data unit specifies a first group of time slots during which any one of the handsets can transmit data to the wireless aggregation point, but the first beacon data unit does not assign any particular time slots in the first group to any particular handsets. The method further includes transmitting the first beacon data unit to the handsets. The method further includes receiving data from a handset during one of the first group of time slots. The method further includes transmitting an acknowledgement to that handset. The method further includes generating a second beacon data unit. The second beacon data unit specifies a second group of time slots during which any one of the handsets can transmit data to the wireless aggregation point, but the first beacon data unit does not assign any particular time slots in the second group to any particular handsets. The method further includes transmitting the second beacon data unit to a second handsets, receiving data from the second handset during one of the time slots in the second group, and transmitting an acknowledgement to the second handset.

### BRIEF DESCRIPTION OF THE DRAWINGS

FIG. 1 is a block diagram illustrating an example audience response system 100 with dynamic multiple access capabilities;

FIG. 2 is a timing diagram illustrating an example dynamic multiple access scheme;

FIG. 3 is a block diagram illustrating the architecture of an example handset with dynamic multiple access capabilities;

FIG. 4 is a flowchart illustrating an example method for communicating via a common wireless channel;

FIG. 5 is a block diagram of an example architecture of a control station with dynamic multiple access capabilities; and

FIG. 6 is a flowchart illustrating an example method for controlling multiple handsets in an audience response system.

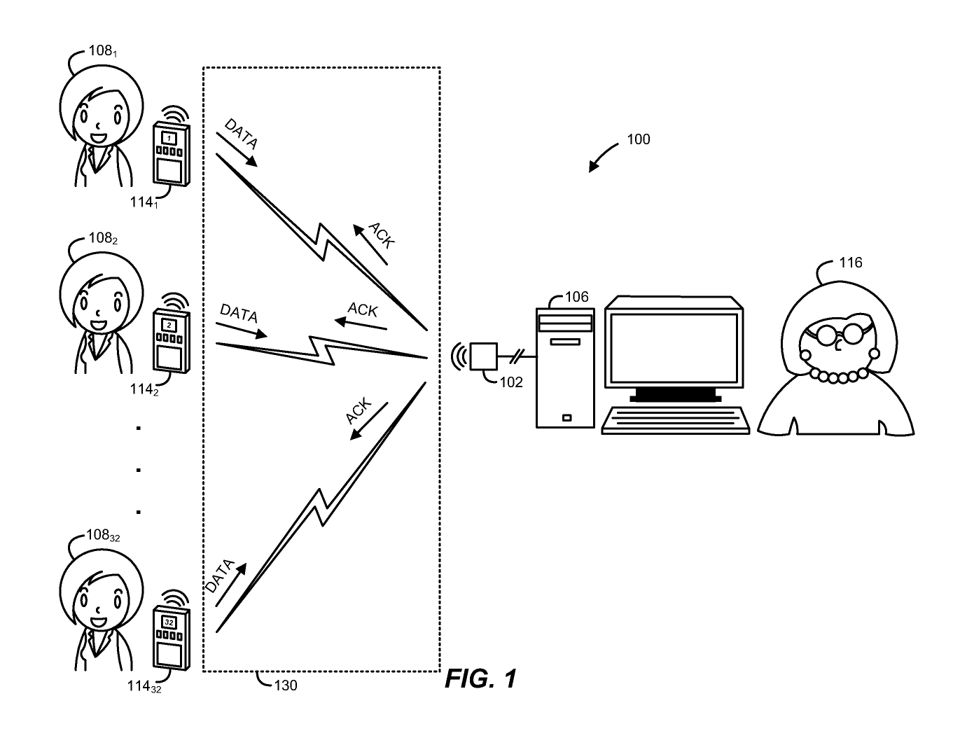

Like reference numbers and designations in the various drawings indicate like elements. Furthermore, when individual elements are designated by references numbers in the form N_{M}, these elements may be referred to collectively by N. For example, FIG. 1 illustrates handsets 114₁, 114₂, . . . , 114₃₂, and two or more of such handsets may be referred to collectively as handset 114, or handsets 114.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘_’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

### Overview of an Example Audience Response System

FIG. 1 is a block diagram illustrating an example audience response system 100 with dynamic multiple access capabilities. For ease of explanation, various components of the example audience response system 100 (and similar systems) will be described in the context of a classroom environment, where a teacher 116 may interact with one or more students 108 using the audience response system 100. However, it will be understood by one of ordinary skill in the art that the example audience response system 100, as well as individual components thereof, may be used in other settings (e.g., corporate training, focus groups, and so on).

The example audience response system 100 includes multiple handsets 114 that may be used by students 108 to answer questions (e.g., posed by a teacher 116), vote on a topic, confirm attendance, and so on. Generally, the handsets 114 may be configured to receive user input (such as answers to a multiple-choice questions) from students 108 and to transmit data indicative of the user input wirelessly over a common wireless channel 130 (e.g., using radio frequency (RF) or infrared (IR) communication technology) to one or more wireless aggregation points 102. A wireless aggregation point 102 may be coupled to a control station 106, and the control station 106, the wireless aggregation point 102, or a combination thereof may be used to process the user input data.

Additionally, in order to ensure proper delivery of data from the handsets 114 to the wireless aggregation point 102, the data communicated from the handsets 114 to the wireless aggregation point 102 is acknowledged using a suitable acknowledgment mechanism, such as those known in the art. Therefore, if a particular handset 114 transmits some data to the wireless aggregation point 102 and does not receive, within a predetermined period of time, for example, an acknowledgment (ACK) from the wireless aggregation point 102, confirming the receipt of that data, it may be inferred that the data was lost during, and the handset 114 may retransmit the data.

The phrase “wireless aggregation point” is used here broadly to denote any device (or a combination of devices) that is capable of sending information to and/or receiving information from multiple handsets (thus making the multiple handsets capable of operating simultaneously, or substantially simultaneously). Examples of a wireless aggregation point include base stations, RF USB/Serial dongles, IR USB/Serial dongles, wireless access points (as per IEEE 802.11, IEEE 802.16, or other wireless communication protocols and standard), etc. The phrase “control station” is also used here broadly to denote any device (or a combination of devices) that is capable of controlling, at least partially, the wireless aggregation point and/or the handsets 114 and processing data received from the handsets 114. It will be understood that in some embodiments, or in some modes of operation, the control station and the wireless aggregation point are not separate elements. Therefore, the phrases “wireless aggregation point” and “control station” may be used to refer to both the wireless aggregation point and the control station.

In the example audience response system 100 illustrated in FIG. 1, the handsets 114, the wireless aggregation point and the control station, together or in combination, implement a dynamic multiple access scheme that will be discussed below in more detail. Much of the functionality of the dynamic multiple access scheme may be implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present disclosure, further discussion of such software and ICs, if any, will be limited to the essentials with respect to the principles and concepts of the preferred embodiments.

### Example Dynamic Multiple Access Scheme

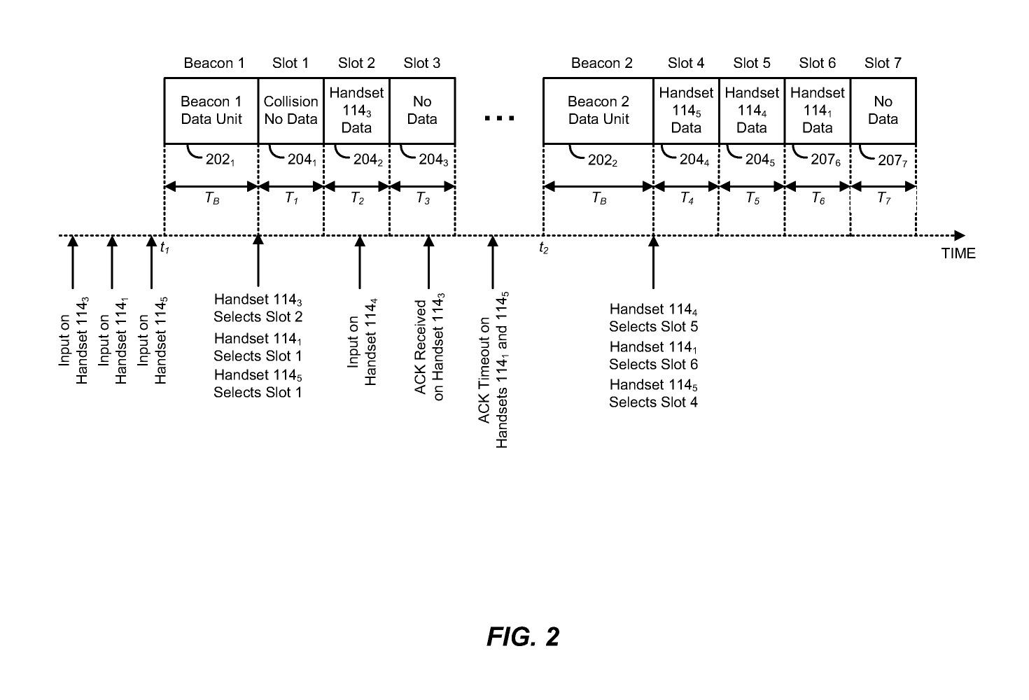

FIG. 2 is a timing diagram that illustrates an example dynamic multiple access scheme. For ease of explanation, the example dynamic multiple access scheme will be described with reference to FIG. 1. However, it will be understood that while much of the functionality of the dynamic multiple access scheme may be distributed among the control station 106, the wireless access point 102, and/or one or more handsets 114, or a combination thereof, the example dynamic multiple access scheme may be utilized with audience response systems that are different from the audience response system 100 of FIG. 1.

Generally, in order to enable the handsets 114 to share the wireless channel 130 efficiently, the control station 106, the wireless aggregation point 102, or a combination thereof, may send out “beacon” data units 202 (further “beacon frames 202”) to the handsets 114 in the student response system, and each beacon frame 202 identifies time slots 204 during which the handsets 114 can transmit data via the wireless channel. However, the beacon frames 202 do not assign any particular time slots 204 to any particular handsets 114 or vice versa. Instead, the handsets 114 themselves select the time slots 204 during which to transmit data.

In the example illustrated in FIG. 2, at time tⱼ, handsets 114 receive a beacon frame 202₁ specifying that, following the beacon frame 202₁ (i.e., at time t₁+T_{B}), there are 3 time slots 204 (slot 1-slot 3) that may be selected by individual handsets 114 for transmission, and that the duration of slot 1 is T₁, the duration of slot 2 is T₂, and the duration of slot 3 is T₃. Similarly, at a later time t₂, the handsets 114 receive another beacon frame 202₂, specifying that, following that beacon frame 202₂ (i.e., at time t₂+T_{B}), there are 4 time slots (slot 4-slot 7) that may be selected by individual handsets 114 to transmit data, and that the duration of slot 4 is T₄, the duration of slot 5 is T₅, the duration of slot 6 is T₆, and the duration of slot 7 is T₇.

When a given handset 114 receives a beacon frame 202, if that handset 114 has data to transmit to the wireless aggregation point 102, the handset may select one or more of the time slots 204 specified by the received beacon frame 202 (e.g., randomly or pseudo-randomly) and transmit that data during the selected time slot 204. If the handset 114 receives an ACK for the transmitted data in a timely manner (e.g., within a predetermined ACK timeout period), it may be inferred that the data was transmitted properly. Otherwise, the handset 114 may wait to receive another beacon frame 202 from the base station and attempt to retransmit the unacknowledged data in one of the time slots 204 specified by that other beacon. This process may continue until the transmitted data is properly acknowledged, or until another event (e.g., a timeout) occurs.

In the example illustrated in FIG. 2, prior to time t₁, handsets 114₁, 114₃ and 114₅ receive user input from students, so these handsets 114₁, 114₃ and 114₅ have data to transmit by the time the first beacon frame 202₁ arrives. Handset 114₃ selects slot 2 for transmitting its data, and handsets 114₁ and 114₅ select slot 1. Handset 114₃ transmits its data during slot 2 and receives an ACK for that data in a timely manner. However, because two handsets 114₁ and 114₅ select slot 1, a collision occurs. Thus handsets 114₁ and 114₅ both transmit data during slot 1 but no data is successfully received by the wireless aggregation point 102. As a result, ACKs for data from handsets 114₁ and 114₅ are not received at the respective handsets 114 in a timely manner.

After the first beacon frame 202₁ is received, handset 114₄ receives input from a student. Handset 114₄ waits until the next beacon frame 202₂ is received and selects time slot 5 to transmit its data. Additionally, because the timeout period for receiving ACKs for data from handsets 114₁ and 114₅ expires prior to arrival of the second beacon frame 202₂, handsets 114₁ and 114₅ select slots 6 and 4, respectively, specified by the second beacon frame 202₂, and retransmit their data during those slots.

It will be understood that a beacon frame may include additional information. For instance, the beacon frame may include data that identifies the base station 102 from which the beacon originates. This data may help handsets 114 to validate that the beacon comes from a trusted source. Moreover, identifying the base station 102 in the beacon may allow multiple base stations 102, or multiple audience response system to operate in close proximity (e.g., in the same classroom).

### Example Handset with Dynamic Multiple Access Capabilities

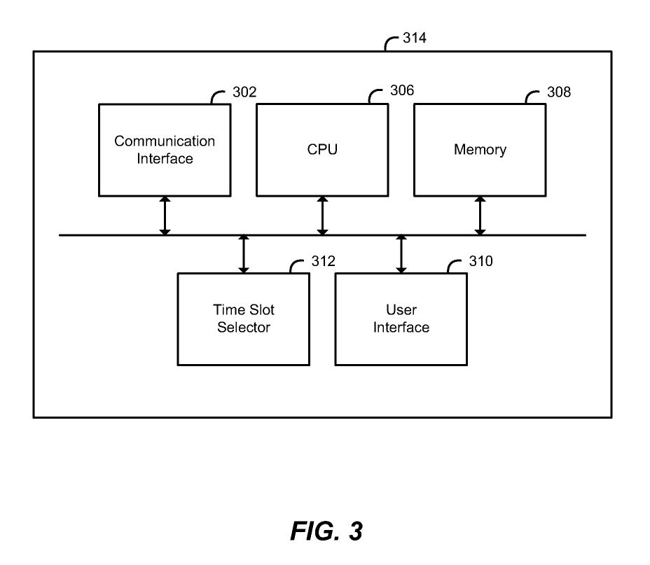

FIG. 3 is a block diagram illustrating the architecture of an example handset 314 with dynamic multiple access capabilities. The example handset 314 may be utilized in the audience response system 100 illustrated in FIG. 1 as a handset 114. It will be understood, however, that the handset 314 may be alternatively used in other audience response systems, and that audience response system 100 illustrated in FIG. 1 may utilize a handset 114 that has an architecture that is different from that of the handset 314 illustrated in FIG. 3.

The handset 314 includes a user interface 310 generally configured to receive user input from a student and to communicate data indicative of the user input to the wireless aggregation point, such as the wireless aggregation point 102 of FIG. 1. The user interface 310 may include one or more user input interface elements (e.g., buttons, icons on a touchscreen, and so on) configured to enable a user to answer questions presented in an audience interaction environment such as a classroom. The user interface 310 may further include one or more output interface elements (e.g., an output display), for example, to provide an electronic indication of one or more operating parameters of the handset. Examples of suitable user interfaces 310 are discussed in more detail in the Provisional Application No. 61/265,140, entitled “DYNAMIC USER INTERFACE FOR USE IN AN AUDIENCE RESPONSE SYSTEM,” filed on Nov. 30, 2009, which is herein incorporated by reference in its entirety.

The handset 314 further includes a communication interface 302. The communication interface 302 is configured to receive beacon frames (such as beacon frames 202 discussed in reference to FIG. 2) that specify time slots (such as time slots 204 in FIG. 2) during which any one of the handsets 114 can transmit data via the wireless channel 130 to the wireless aggregation point 102. As explained above, beacon frames do not assign any particular time slots to any particular handsets 114. Instead, each handsets 114, such as the handset 314 illustrated in FIG. 3, uses a time slot selector 312 to select (e.g., randomly, or pseudo-randomly) one or more of the time slots specified by the beacon frames and transmits data during the selected time slots using the communication interface 302.

In addition to the communication interface 302 and the user interface 310, the handset 314 may include a number of other units, or components. For example, the handset 314 may include a central processing unit (CPU) 306 and a memory 308 coupled to the CPU 306. The CPU may be configured to execute computer readable instructions stored in memory 308 in order to implement at least some of the functions of the handset 314 described above.

It will be understood that the handset 314, in some embodiments, or in some modes of operation, may not include one or more of the components 302-312 or, alternatively, may not use each of the components 302-312 for implementing a multiple access scheme described herein. Further, it will be appreciated that some of the components 302-312 may be combined or divided into more components. Still the handset 314 may include additional components that, for ease of explanation, are not shown in FIG. 3.

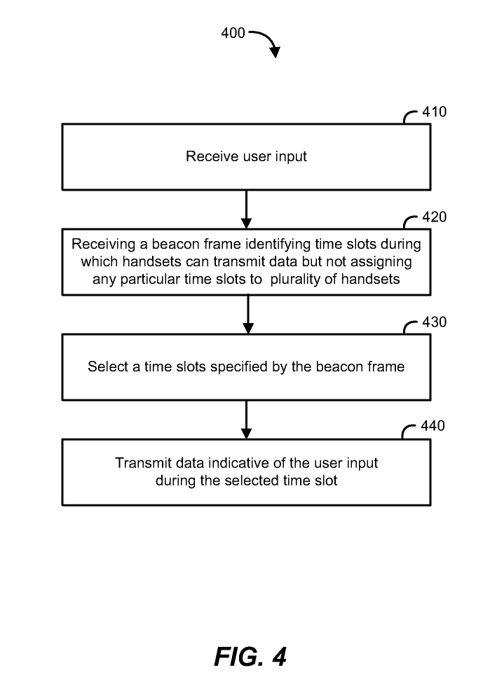

FIG. 4 is a flowchart illustrating an example method 400 for communicating via a common wireless channel for use in an audience response system, such as the example audience response system 100 illustrated in FIG. 1. For ease of explanation, FIG. 4 will be described in reference to FIGS. 1-3. However, it will be understood that the example method 400 for communicating via a common wireless channel for use in an audience response system can be utilized with systems, devices and configurations other than those shown in FIGS. 1-3.

When a handset, such as handset 314 in FIG. 3 received an input from a user (block 410), the handset waits to receive a beacon frame (such as a beacon frame 202 for FIG. 2) before transmitting, to the wireless aggregation point and via the wireless channel, data indicative of the user input. When the handset receives the beacon frame, the beacon frame specifies multiple time slots during which any one of the handsets in the audience response system can transmit data to the wireless aggregation point. However, the beacon frame does not assign any particular time slots to any particular handsets (block 420). Instead, the handset selects (e.g., randomly or pseudo-randomly) one of the time slots specified by the beacon frame (block 430) and transmits data related to the user input via the wireless channel, to the wireless aggregation point, during the selected time slot (block 430).

### Example Control Station

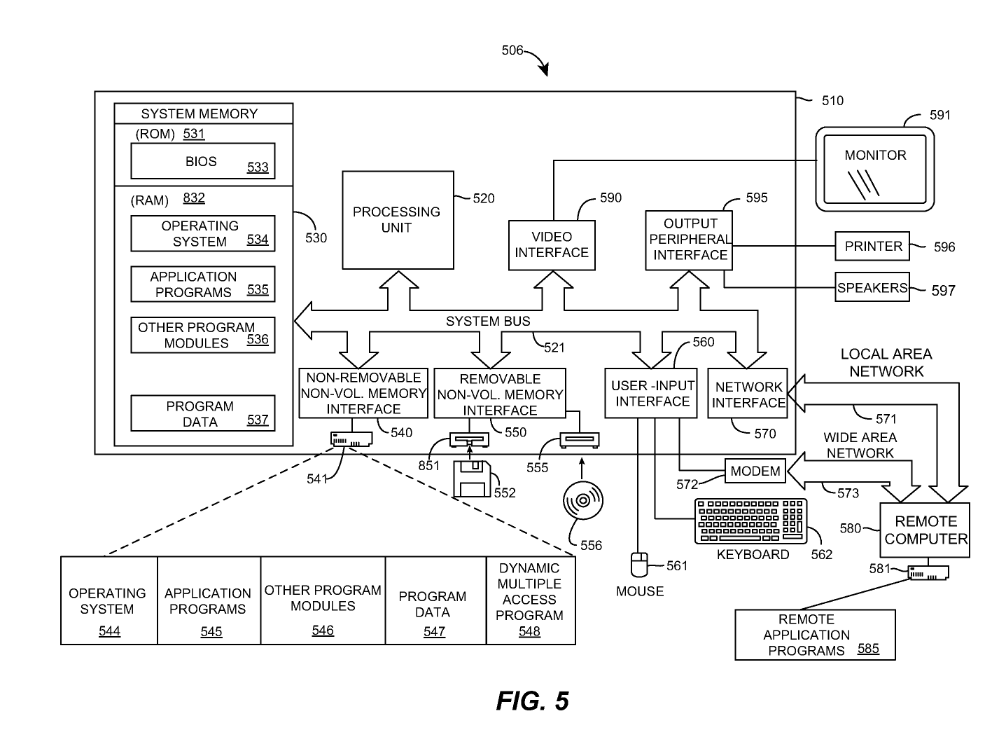

FIG. 5 is a block diagram of an example architecture of a control station 506. The example control station 506 may be utilized in the audience response system 100 illustrated in FIG. 1 as a control station 106. It will be understood, however, that the control station 506 may be alternatively used in other audience response systems, and that the audience response system 100 illustrated in FIG. 1 may utilize a control station 106 that has an architecture that is different from that of the control station 506 illustrated in FIG. 5.

Components of the control station 506 may include, but are not limited to a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Control station 506 typically includes a variety of computer readable media. Computer readable media can be any available media that can be accessed by control station 506 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by control station 506. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within control station 506, such as during start-up, is typically stored in ROM 531. RAM 532 typically contains data and/or program modules that are immediately accessible to and/or presently being operated on by processing unit 520. By way of example, and not limitation, FIG. 5 illustrates operating system 544, application programs 545, other program modules 546, program data 537 and a dynamic multiple access program 548. It should be noted, however, that at least some of the program modules 544-548, may implemented, at least partially, by entities in an audience response system other than the control station 506. For example, at least a portion of the dynamic multiple access program 548 may be distributed among the control station 506, and the wireless access point, among multiple control stations 506 and/or multiple wireless access points, and among other devices within an audience response system.

The control station 506 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the control station 506. In FIG. 5, for example, hard disk drive 541 is illustrated as storing operating system 544, application programs 545, other program modules 546, and program data 547. Note that these components can either be the same as or different from operating system 534, application programs 535, other program modules 536, and program data 537. Operating system 544, application programs 545, other program modules 546, and program data 547 are given different numbers here to illustrate that, at a minimum, they are different copies. A user may enter commands and information into the computer 20 through input devices such as a keyboard 562 and cursor control device 561, commonly referred to as a mouse, trackball or touch pad. A camera 563, such as web camera (webcam), may capture and input pictures of an environment associated with the control station 506, such as providing pictures of users. The webcam 563 may capture pictures on demand, for example, when instructed by a user, or may take pictures periodically under the control of the control station 506. Other input devices (not shown) may include a microphone, joystick, game pad, satellite dish, scanner, or the like. These and other input devices are often connected to the processing unit 520 through an input interface 560 that is coupled to the system bus, but may be connected by other interface and bus structures, such as a parallel port, game port or a universal serial bus (USB). A monitor 591 or other type of display device is also connected to the system bus 521 via an interface, such as a graphics controller 590. In addition to the monitor, computers may also include other peripheral output devices such as speakers 597 and printer 596, which may be connected through an output peripheral interface 595.

The control station 506 may operate in a networked environment using logical connections to one or more remote computers, such as a remote computer 580. The remote computer 580 may be a personal computer, a server, a router, a network PC, a peer device or other common network node, and typically includes many or all of the elements described above relative to the control station 506, although only a memory storage device 581 has been illustrated in FIG. 2A. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the control station 506 is connected to the LAN 571 through a network interface or adapter 570. When used in a WAN networking environment, the control station 506 typically includes a modem 572 or other means for establishing communications over the WAN 573, such as the Internet. The modem 572, which may be internal or external, may be connected to the system bus 521 via the input interface 560, or other appropriate mechanism. In a networked environment, program modules depicted relative to the control station 506, or portions thereof, may be stored in the remote memory storage device. By way of example, and not limitation, FIG. 5 illustrates remote application programs 585 as residing on memory device 581.

The communications connections 570, 572 allow the device to communicate with other devices. The communications connections 570, 572 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

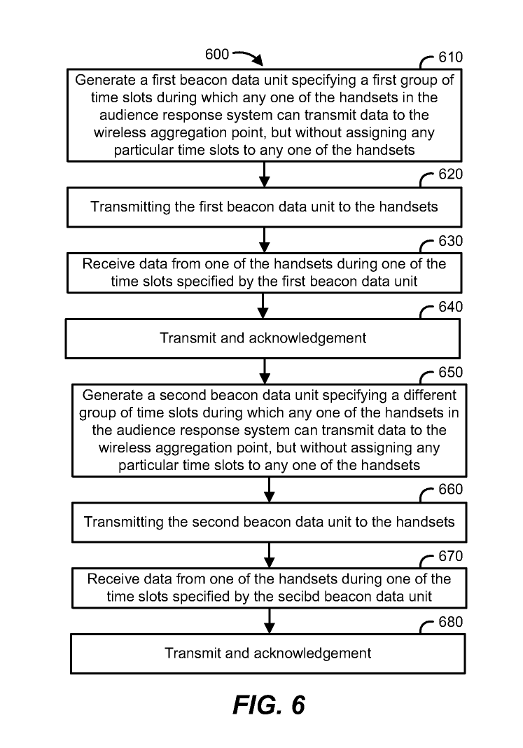

FIG. 6 is a flowchart illustrating an example method 600 for controlling multiple handsets in an audience response system to communicate via a common wireless channel that can be implemented, at least partially, on a control station such as the control station 506 illustrated in FIG. 5. For ease of explanation, FIG. 6 will be described in reference to FIGS. 1-5. However, it will be understood that the example method 600 for controlling multiple handsets in an audience response system to communicate via a common wireless channel can be utilized with systems, devices, configurations and methods other than those shown in FIGS. 1-5. Furthermore, it will be understood that at least a portion of the method 600 for controlling multiple handsets in an audience response system to communicate via a common wireless channel may be distributed among other control stations, one or more wireless aggregation points, one or more handsets, or a combination thereof.

Generally, the control station can generate, and transmit to the handsets in the audience response system, beacon frames specifying different time slots, depending on the traffic in the audience response system. For example, if only a few handsets are active, the control station may transmit beacon frames that specify relatively few time slots of relatively long duration. On the other hand, if many of the handsets are active, the control station may transmit beacon frames that specify more time slots of with shorter duration. As a result, beacon frames transmitted to the handsets may be configured, and reconfigured, based on the activity in the audience response system.

More specifically, in some embodiments, the control system may generate a first beacon data unit specifying a first group of time slots during which any one of the handsets in the audience response system can transmit data to the wireless aggregation point, but without assigning any particular time slots to any one of the handsets (block 610). The control station may then transmit the first beacon data unit to the handsets (block 620), receive data from one of the handsets during one of the time slots specified by the first beacon data unit (block 630) and transmit an acknowledgement to that handset (640). Subsequently, the control system may generate a second beacon data unit specifying a second, different group of time slots (e.g., with a different number of time slots, or with different duration per time slot) during which any one of the handsets in the audience response system can transmit data to the wireless aggregation point, again without assigning any particular time slots to any one of the handsets (block 650). The control station may then transmit the second beacon data unit to the handsets (block 660), receive data from one of the handsets during one of the time slots specified in the second beacon data unit (block 670) and transmit an acknowledgement to that handset (block 680).

Particular embodiments of the dynamic multiple access technique have been illustrated and described. However, it would be obvious to those skilled in the art that various other changes and modifications can be made without departing from the spirit and scope of the present disclosure. For example, the dynamic multiple access technique described herein may be used with a variety of different wireless systems other than audience response systems. It is therefore intended to cover in the appended claims all such changes and modifications that are within the scope of this disclosure.

What is claimed is:

1. A method for communicating via a wireless communication channel for use in an audience response system, the audience response system including a wireless aggregation point and a plurality of handset configured to communicatively couple to the wireless aggregation point via the wireless communication channel, the method comprising:
receiving an input from a user at a given one of the plurality of handsets;
receiving a beacon data unit at the given one of the plurality of handsets via the wireless aggregation point, wherein the beacon data unit specifies a plurality of time slots during which any one of the plurality of handsets can transmit data to the wireless aggregation point, and wherein the beacon data unit does not assigning any particular one of the plurality of time slots to any one of the plurality of handsets;
selecting one of the plurality of time slots specified in the beacon data unit; and
transmitting data related to the input received from the user at the given one of the plurality of handsets from the given one of the plurality of handsets to the wireless aggregation point during the selected time slot.

2. The method of claim 1, wherein selecting the one of the plurality of time slots specified in the beacon data unit comprises selecting the one of the plurality of time slots specified in the beacon data unit randomly or pseudo-randomly.

3. The method of claim 1, wherein the beacon data unit specifies at least one of a number of the plurality of time slots and a duration for each of the plurality of time slots.

4. The method of claim 1, further comprising retransmitting the data related to the input received from the user at the given one of the plurality of handsets from the given one of the plurality of handsets to the wireless aggregation point if an acknowledgment is not received from the data related to the input received from the user at the given one of the plurality of handsets.

5. The method of claim 4, wherein the beacon data unit is a first beacon data unit, the plurality of time slots is a first plurality of time slots and the selected time slot is a first selected time slot, and wherein retransmitting the data related to the input received from the user at the given one of the plurality of handsets comprises:
receiving a second beacon data unit at the given one of the plurality of handsets via the wireless aggregation point, wherein the second beacon data unit specifies a second plurality of time slots during which any one of the plurality of handsets can transmit data to the wireless aggregation point, and wherein the second beacon data unit does not assigning any particular one of the second plurality of time slots to any one of the plurality of handsets;
selecting a second one of the plurality of time slots specified in the second beacon data unit; and
transmitting data related to the input received from the user at the given one of the plurality of handsets from the given one of the plurality of handsets to the wireless aggregation point during the second selected time slot.

6. The method of claim 5, wherein the second beacon data unit specifies at least one of a number of the second plurality of time slots and a duration for each of the second plurality of time slots, and wherein at least one of the number of the second plurality of time slots and the duration for each of the second plurality of time slots is different from the corresponding one of a number of the first plurality of time slots and a duration for each of the first plurality of time slots.

7. The method of claim 1, wherein receiving the beacon data unit is subsequent to receiving the input from the user at a given one of the plurality of handsets.

8. A wireless handset for use in an audience response system, the audience response system including a wireless aggregation point and a plurality of handsets configured to communicatively couple to the wireless aggregation point, the wireless handset comprising:
a user interface configured to receive an input from a user;
a communication interface configured to:
receive a beacon data unit via the wireless aggregation point, the beacon data unit specifying a plurality of time slots during which any one of the plurality of handsets can transmit data to the wireless aggregation point, the beacon data unit not assigning any particular one of the plurality of time slots to any one of the plurality of handsets; and
transmit data related to the input received from the user to the wireless aggregation point during a selected one of the plurality of time slots; and
a time slot selector configured to select the one of the plurality of time slots.

9. The wireless handset of claim 8, wherein the time slot selector is configured to select the one of the plurality of time slots specified in the beacon data unit by selecting the one of the plurality of time slots specified in the beacon data unit randomly or pseudo-randomly.

10. The wireless handset of claim 8, wherein the beacon data unit specifies at least one of a number of the plurality of time slots and a duration for each of the plurality of time slots.

11. The wireless handset of claim 8, wherein the communication interface is further configured to retransmit the data related to the input received from the user at the given one of the plurality of handsets from the given one of the plurality of handsets to the wireless aggregation point if an acknowledgment is not received from the data related to the input received from the user at the given one of the plurality of handsets.

12. The wireless handset of claim 11, wherein the beacon data unit is a first beacon data unit, the plurality of time slots is a first plurality of time slots and the selected time slot is a first selected time slot, and wherein to retransmit the data related to the input received from the user at the given one of the plurality of handsets comprises:
to receive a second beacon data unit at the given one of the plurality of handsets via the wireless aggregation point, wherein the second beacon data unit specifies a second plurality of time slots during which any one of the plurality of handsets can transmit data to the wireless aggregation point, and wherein the second beacon data unit does not assigning any particular one of the second plurality of time slots to any one of the plurality of handsets; and
to transmit data related to the input received from the user at the given one of the plurality of handsets from the given one of the plurality of handsets to the wireless aggregation point during a second selected time slot;
wherein the time slot selector is configured to selects the second one of the plurality of time slots specified in the second beacon data unit.

13. The wireless handset of claim 12, wherein the second beacon data unit specifies at least one of a number of the second plurality of time slots and a duration for each of the second plurality of time slots, and wherein at least one of the number of the second plurality of time slots and the duration for each of the second plurality of time slots is different from the corresponding one of a number of the first plurality of time slots and a duration for each of the first plurality of time slots.

14. The wireless handset of claim 8, wherein the beacon data unit includes data identifying the wireless aggregation point.

15. An audience response system comprising:
a wireless aggregation point; and
a plurality of handsets communicatively coupled to the wireless aggregation point, wherein at least one of the plurality of handsets comprises:
a user interface configured to receive an input from a user;
a communication interface configured to:
receive a beacon data unit via the wireless aggregation point, the beacon data unit specifying a plurality of time slots during which any one of the plurality of handsets can transmit data to the wireless aggregation point, the beacon data unit not assigning any particular one of the plurality of time slots to any one of the plurality of handsets; and
transmit data related to the input received from the user to the wireless aggregation point during a selected one of the plurality of time slots; and
a time slot selector configured to select the one of the plurality of time slots.

16. The audience response system of claim 15, wherein the time slot selector is configured to select the one of the plurality of time slots specified in the beacon data unit by selecting the one of the plurality of time slots specified in the beacon data unit randomly or pseudo-randomly.

17. The audience response system of claim 15, wherein the beacon data unit specifies at least one of a number of the plurality of time slots and a duration for each of the plurality of time slots.

18. The audience response system of claim 15, wherein the communication interface is further configured to retransmit the data related to the input received from the user at the given one of the plurality of handsets from the given one of the plurality of handsets to the wireless aggregation point if an acknowledgment is not received from the data related to the input received from the user at the given one of the plurality of handsets.

19. The audience response system of claim 18, wherein the beacon data unit is a first beacon data unit, the plurality of time slots is a first plurality of time slots and the selected time slot is a first selected time slot, and wherein to retransmit the data related to the input received from the user at the given one of the plurality of handsets comprises:
to receive a second beacon data unit at the given one of the plurality of handsets via the wireless aggregation point, wherein the second beacon data unit specifies a second plurality of time slots during which any one of the plurality of handsets can transmit data to the wireless aggregation point, and wherein the second beacon data unit does not assigning any particular one of the second plurality of time slots to any one of the plurality of handsets; and
to transmit data related to the input received from the user at the given one of the plurality of handsets from the given one of the plurality of handsets to the wireless aggregation point during a second selected time slot;
wherein the time slot selector is configured to selects the second one of the plurality of time slots specified in the second beacon data unit.

20. The audience response system of claim 19, wherein the second beacon data unit specifies at least one of a number of the second plurality of time slots and a duration for each of the second plurality of time slots, and wherein at least one of the number of the second plurality of time slots and the duration for each of the second plurality of time slots is different from the corresponding one of a number of the first plurality of time slots and a duration for each of the first plurality of time slots.

21. The wireless handset of claim 15, wherein the beacon data unit includes data identifying the wireless aggregation point.

22. A method for use in a computing system configured to operate with an audience response system, the audience response system including a wireless aggregation point and a plurality of handsets configured to communicatively couple to the wireless aggregation point via the wireless communication channel, the computing system having a processor and a memory coupled the processor, the memory storing computer-readable instructions executable on the processor, the method comprising:
generating a first beacon data unit, the first beacon data unit specifying a first plurality of time slots during which any one of the plurality of handsets can transmit data to the wireless aggregation point, the first beacon data unit not assigning any particular one of the first plurality of time slots to any one of the plurality of handsets;
transmitting the first beacon data unit to the plurality of handsets;
receiving data from a first one of the plurality of handsets during one of the first plurality of time slots;
transmitting an acknowledgement to the first one of the plurality of handsets;
generating a second beacon data unit, the second beacon data unit specifying a second plurality of time slots during which any one of the plurality of handsets can transmit data to the wireless aggregation point, the second beacon data unit not assigning any particular one of the second plurality of time slots to any one of the plurality of handsets;
transmitting the second beacon data unit to the plurality of handsets;
receiving data from a second one of the plurality of handsets during one of the second plurality of time slots; and
transmitting an acknowledgement to the second one of the plurality of handsets;
wherein the first plurality of time slots has different parameters than the second plurality of time slots.

23. The method of claim 22, wherein the first beacon data unit specifies at least one of a number of the first plurality of time slots and a duration for each of the first plurality of time slots, and wherein the second beacon data unit specifies at least one of a number of the second plurality of time slots and a duration for each of the second the plurality of time slots.

24. The method of claim 23, wherein the at least one of the number of the first plurality of time slots and the duration for each of the first plurality of time slots is different from the corresponding at least one of the number of the second plurality of time slots and the duration for each of the second plurality of time slots.

25. A computer program product for use with an audience response system, the audience response system including a wireless aggregation point and a plurality of handsets configured to communicatively couple to the wireless aggregation point via the wireless communication channel, the computer program product having a processor and a memory coupled the processor, the memory storing computer-readable instructions executable on the processor to perform the steps of:
generating a first beacon data unit, the first beacon data unit specifying a first plurality of time slots during which any one of the plurality of handsets can transmit data to the wireless aggregation point, the first beacon data unit not assigning any particular one of the first plurality of time slots to any one of the plurality of handsets;
transmitting the first beacon data unit to the plurality of handsets;
receiving data from a first one of the plurality of handsets during one of the first plurality of time slots;
transmitting an acknowledgement to the first one of the plurality of handsets;
generating a second beacon data unit, the second beacon data unit specifying a second plurality of time slots during which any one of the plurality of handsets can transmit data to the wireless aggregation point, the second beacon data unit not assigning any particular one of the second plurality of time slots to any one of the plurality of handsets;
transmitting the second beacon data unit to the plurality of handsets;
receiving data from a second one of the plurality of handsets during one of the second plurality of time slots; and
transmitting an acknowledgement to the second one of the plurality of handsets;
wherein the first plurality of time slots has different parameters than the second plurality of time slots.

26. The computer program product of claim 25, wherein the first beacon data unit specifies at least one of a number of the first plurality of time slots and a duration for each of the first plurality of time slots, and wherein the second beacon data unit specifies at least one of a number of the second plurality of time slots and a duration for each of the second the plurality of time slots.

27. The computer program product of claim 26, wherein the at least one of the number of the first plurality of time slots and the duration for each of the first plurality of time slots is different from the corresponding at least one of the number of the second plurality of time slots and the duration for each of the second plurality of time slots.
